(19) United States
(12) Patent Application Publication
(10) Pub. No.: US 2007/0129179 A1
(43) Pub. Date: Jun. 7, 2007

(54) Handheld electronic caddy scorekeeping device for a golfer

(76) Inventor: Louis Soto, Danville, IN (US)

Correspondence Address: Galasso & Associates, LP, P.O. Box 26503, Austin, TX, 78755-0503, US

(21) Appl. No.: 11/633,890

(22) Filed: Dec. 5, 2006

Related U.S. Application Data
(60) Provisional application No. 60/742,484, filed on Dec. 5, 2005.

(51) Int. Cl. G06F 19/00

(52) U.S. Cl. 473/407; 473/131; 700/92

(57) ABSTRACT

An electronic handheld scorekeeping device is provided for use by a golfer. The electronic handheld scorekeeping device includes an electronic screen and a user input device in the form of a keypad. The electronic handheld scorekeeping device includes a central processing unit (CPU) programmed for performing golf scorekeeping, calculating a golfer's handicap, providing shot by shot information of each hole played, displaying the rules of the game of golf, and providing the characteristics of a plurality of golf courses including par value per hole, fairway characteristics, general course layout and topography.

### CROSS REFERENCE TO RELATED APPLICATIONS

This application claims priority to co-pending U.S. Provisional Patent Application having Ser. No. 60/742,484 filed Dec. 5, 2005 entitled “Electronic Caddy”, having a common applicant herewith.

### FIELD OF THE DISCLOSURE

The disclosures made herein relate generally to a golf scorekeeping and handicap calculation device and more particularly to an electronic handheld device configured to allow a golfer to perform golf scorekeeping, calculate a golfer's handicap, provide shot by shot information of each hole played, display the rules of the game of golf, and provide the characteristics of a plurality of golf courses from a memory stored record.

### BACKGROUND

The rules and methods of scorekeeping and handicap calculation in the game of golf are well known. Those skilled in the game of golf know of various types of paper scorekeeping forms and scorecards that are in common use. The prior art includes:

Plumbridge (U.S. Pat. No. 4,645,105) discloses a golfer's accessory scorekeeping board having a means of clamping a scorecard onto the body.

Kasko (U.S. Pat. No. 5,284,240) discloses a folding golf scorecard and playing booklet disclosing layout and hole par information for a golf course along with a manual golf score record card.

Reeves (U.S. Pat. No. 5,740,077) discloses a golf round data system adapted to be carried by the user and providing record keeping and golfer location on a golf course.

While these scorecards and systems fulfill their desired functions, such scorecards and systems do not offer a scorekeeping system having numeric calculation and electronic record retention capabilities, permitting a golfer to track handicap with automatic calculation, score during the round of golf and record data related to each hole played.

Therefore, a handheld electronic scorekeeping device configured for overcoming the drawbacks of such conventional approaches for golf scorekeeping would be useful, advantageous and novel.

### SUMMARY OF THE DISCLOSURE

In one embodiment of the inventive disclosures presented herein, an electronic handheld scorekeeping device is provided for use by a golfer. The electronic handheld scorekeeping device includes a viewable electronic screen providing alpha/numeric and graphic display capabilities. The viewable electronic screen is secured to a first portion of the device. A user input device in the form of a keypad is secured to a second portion of the device. The electronic handheld scorekeeping device includes a central processing unit (CPU) and programmed logic executable stored to memory on the device and adapted to execute on the central processing unit. The programmed logic is programmed for performing golf scorekeeping, calculating a golfer's handicap, providing shot by shot information of each hole played, displaying rules of the game of golf, and providing the characteristics of a plurality of golf courses including par number per hole, fairway characteristics, general course layout and topography. The device includes a battery for providing power to operate the electronic device.

In an aspect of the invention, the battery is a rechargeable battery or battery pack which may be charged between uses, eliminating the need to purchase replacement batteries.

In another aspect of the invention, the battery is one or more standard size disposable batteries. The use of disposable batteries provides a lower production cost/price point for the device.

In another aspect of the invention, the display screen is a liquid crystal display (LCD) screen.

In yet another aspect of the invention, the display screen is a backlit LCD screen.

In another aspect of the invention, the display screen is a light emitting diode (LED) display screen.

In another aspect of the invention, the keypad has a plurality of multifunction keys labeled and adapted to permit the golfer to enter numerals 0 through 9; enter alphabetic letters A through Z; select labeled keys having golf shot names including hook, chip, slice, putt, and straight; traps including sand, out of bounds and water, as well as a menu key and a select key. The menu is operable to display menus on the display. The select key is operable to select a displayed menu item.

In another aspect of the invention, the first portion is an upper portion of the front face of the electronic handheld scorekeeping device; and the second portion is a lower portion of the front face of the device.

In another aspect of the invention, the first portion includes a hinged cover hingeably secured to the device, the hinged cover closeably covering the second portion of the device.

In another aspect of the invention, the device is provided in a weatherproof plastic housing suitable for scorekeeping while playing a round of golf in inclement weather.

In another aspect of the invention, the electronic handheld scorekeeping device housing has dimensions measuring five inches in length, three inches in width and a quarter inch in thickness.

In another aspect of the invention, the electronic handheld scorekeeping device includes a removable flash memory card, wherein golf score and handicap information is stored to the flash memory card, wherein the flash memory card is readable by a personal computer, wherein golf score and handicap information is transferable to a personal computer from the flash memory card.

The electronic handheld scorekeeping device is configured and adapted to assist any golfer in improving their game by keeping an accurate record of events after every stroke during a round of golf. Additionally, the device calculates the handicap and provides the golfer with a ready reference to the rules of golf. The golfer enters events during the game by use of special function and numeric keys provided on the keypad. Information recorded in the device during the game is available after the game to assist the golfer in identifying aspects of the golfer's game that would benefit from more practice.

These and other objects and embodiments of the inventive disclosures made herein will become readily apparent upon further review of the following specification and associated drawings.

### BRIEF DESCRIPTION OF THE DRAWINGS

The drawings show a form of the invention that is presently preferred; however, the invention is not limited to the precise arrangement shown in the drawings.

FIG. 1 depicts a perspective view of the front face of one embodiment of the electronic handheld scorekeeping device in accordance with the inventive disclosures presented herein.

FIG. 2 depicts a perspective view of the rear face of one embodiment of the electronic handheld scorekeeping device in accordance with the inventive disclosures presented herein.

FIG. 3 depicts a front view of one embodiment depicting and exemplary keypad arrangement in accordance with the inventive disclosures presented herein.

### DETAILED DESCRIPTION OF THE DRAWINGS

In preparation for explaining the details of the present inventive disclosure, it is to be understood by the reader that the invention is not limited to the presented details of the construction, materials and embodiments as illustrated in the accompanying drawings, as the invention concepts are clearly capable of other embodiments and of being practiced and realized in various ways by applying the disclosure presented herein.

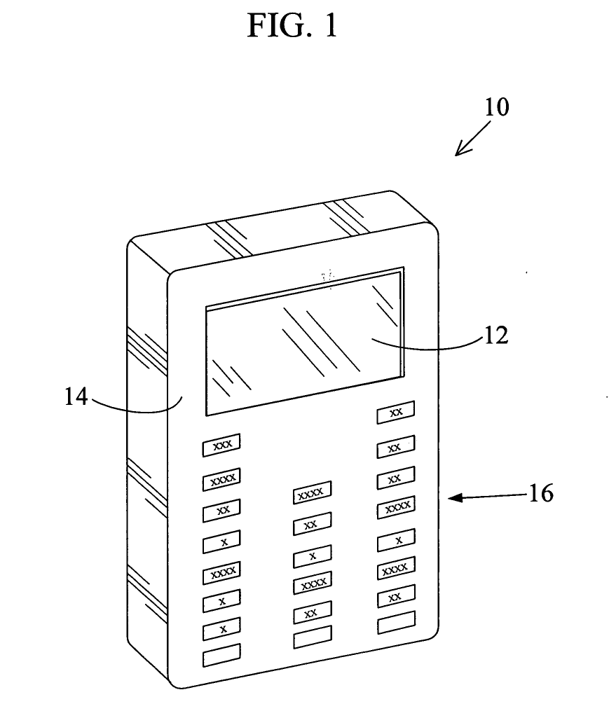

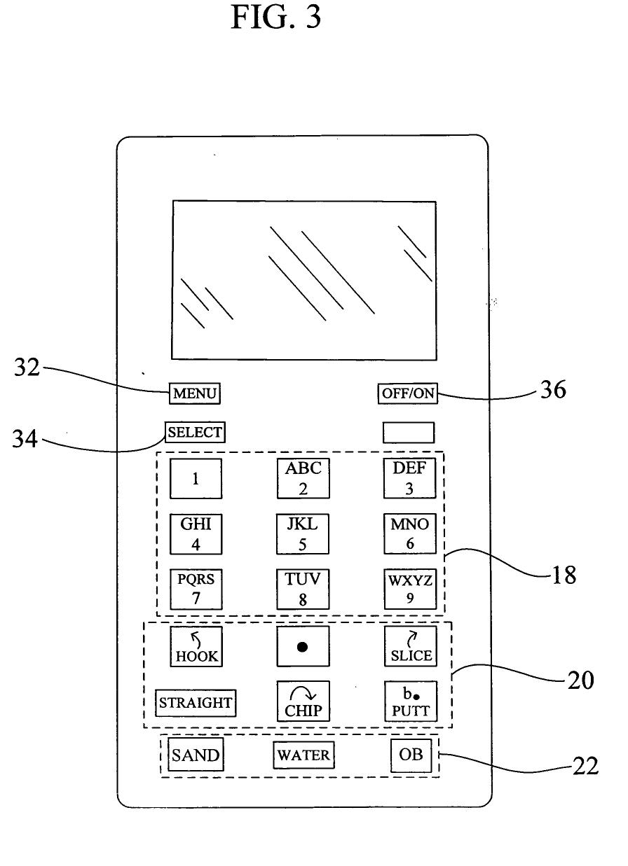

FIG. 1 depicts a perspective view of the front face of one embodiment of the electronic handheld scorekeeping device 10 in accordance with the inventive disclosures presented herein. FIG. 3 depicts a front view of one embodiment depicting and exemplary keypad arrangement in accordance with the inventive disclosures presented herein. The electronic handheld scorekeeping device 10 has an electronic display screen 12 at an upper portion of the front face 14 of the device 10. The display screen 12 provides alpha/numeric and graphic display capabilities. A keypad 16 is secured to a second portion of the device below the electronic display. The keypad provides a means for a user to input data into the device during a round of golf. Multifunction keys 18 provide for the input of numeric digits 0 through 9, as well as alphabetic characters A though Z. Shot keys 20 provide for the input of the type of shot including hook, chip, slice, putt, and straight. Keys 22 permit the user to enter obstacles and traps such as sand, water and out of bounds. Menu key 32 displays a top level menu on the display screen. Select key 34 selects items on the displayed menu. Power key 36 toggles the power to the electronic handheld scorekeeping device 10 between on and off.

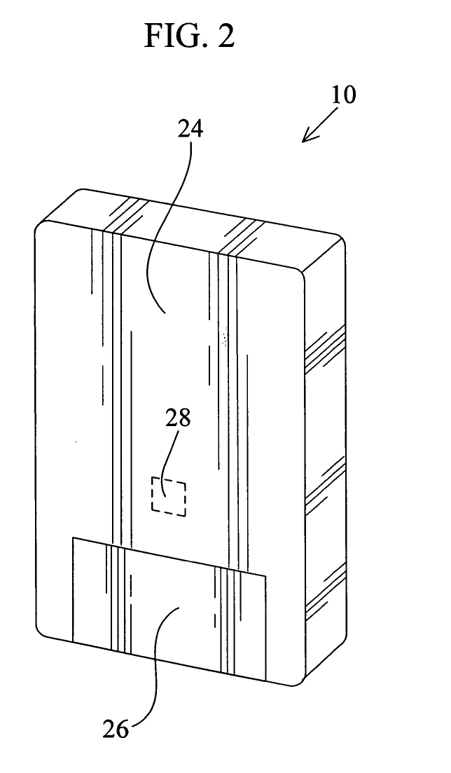

FIG. 2 depicts a perspective view of the rear face 24 of one embodiment of the electronic handheld scorekeeping device in accordance with the inventive disclosures presented herein. Embodiments with disposable batteries include a battery access door 26 located on the rear face 24 of the electronic handheld scorekeeping device 10. A central processing unit (CPU) 28 is provided within the housing of the device 10. The CPU 28 includes memory having programmed logic programmed for performing golf scorekeeping, calculating a golfer's handicap, providing shot by shot information of each hole played, user query for and display of the rules of the game of golf, and providing the characteristics of a plurality of golf courses including par number per hole, fairway characteristics, general course layout and topography.

While playing a golf round, the golfer will enter all relevant data through the keypad 16 on a stroke by stroke basis according to the current hole being played. The central processing unit 28 processes and stores entered data, recording data to memory for later review by the golfer in identifying aspects of the game in which the golfer would benefit from practice. Before playing the round or while playing the golfer enters course and hole specific information including the par value for each hole. The electronic handheld scorekeeping device 10 utilizes the par values and strokes per hole, as entered by the golfer, to calculate the golfer's handicap.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, and mechanical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An electronic handheld scorekeeping device for a golfer, comprising:
a viewable electronic screen providing alpha/numeric and graphic display capabilities, said screen secured on a first portion of the device;
a keypad secured to a second portion of said device, said keypad providing a means for a user to input data into said device;
a central processing unit and programmed logic executable on said central processing unit, said programmed logic programmed for performing golf scorekeeping, calculating a golfer's handicap, providing shot by shot information of each hole played, displaying rules of the game of golf, and providing the characteristics of a plurality of golf courses including par number per hole, fairway characteristics, general course layout and topography; and
a battery providing power to operate said electronic device;
wherein said device assists said golfer to improve their game by keeping an accurate record of events after every stroke during a golf round.

2. The electronic handheld scorekeeping device for a golfer according to claim 1, wherein said battery is a rechargeable battery.

3. The electronic handheld scorekeeping device for a golfer according to claim 1, wherein said battery is a disposable battery.

4. The electronic handheld scorekeeping device for a golfer according to claim 1, wherein said display screen is a LCD screen.

5. The electronic handheld scorekeeping device for a golfer according to claim 4, wherein said display screen is a backlit LCD screen.

6. The electronic handheld scorekeeping device for a golfer according to claim 1, wherein said keypad has a plurality of multifunction keys labeled and adapted to permit the golfer to enter numerals 0 through 9; alphabetic letters A through Z; golf shot names including hook, chip, slice, putt, and straight; traps including sand, out of bounds and water, as well as a menu key and a select key, wherein said menu is operable to display menus on said display;
wherein said select key is operable to select a displayed menu item; and
wherein said numeric keys are operable for entering numeric data.

7. The electronic handheld scorekeeping device for a golfer according to claim 1, wherein said first portion is an upper portion of a front face of said device; and
wherein said second portion is a lower portion of said front face of said device.

8. The electronic handheld scorekeeping device for a golfer according to claim 1, wherein said first portion comprises a hinged cover hingeably secured to said device, said hinged cover closeably covering said second portion of the device.

9. The electronic handheld scorekeeping device for a golfer according to claim 1, wherein said device is provided in a weatherproof plastic housing.

10. The electronic handheld scorekeeping device for a golfer according to claim 9, wherein said housing has dimensions measuring five inches in length, three inches in width and a quarter inch in thickness.

11. The electronic handheld scorekeeping device for a golfer according to claim 1, further comprising:
a removable flash memory card, wherein golf score and handicap information is stored to said flash memory card;
wherein said flash memory card is readable by a personal computer; and
wherein golf score and handicap information is transferable to a personal computer by use of said removable flash memory card.

12. An electronic handheld scorekeeping device for a golfer, comprising:
a viewable electronic screen providing alpha/numeric and graphic display capabilities, said screen secured on a first portion of the device;
a keypad secured to a second portion of said device, said keypad providing a means for a user to input data into said device;
a central processing unit and programmed logic executable on said central processing unit, said programmed logic programmed for performing golf scorekeeping, calculating a golfer's handicap, providing shot by shot information of each hole played, displaying rules of the game of golf, and providing the characteristics of a plurality of golf courses including par number per hole, fairway characteristics, general course layout and topography;
a battery providing power to operate said electronic device; and
a removable flash memory card, wherein golf score and handicap information is stored to said flash memory card;
wherein said keypad includes a plurality of multifunction keys labeled and adapted to permit the golfer to enter numerals 0 through 9; alphabetic letters A through Z; golf shot names including hook, chip, slice, putt, and straight; traps including sand, out of bounds and water, as well as a menu key and a select key, wherein said menu is operable to display menus on said display;
wherein said select key is operable to select a displayed menu item; and
wherein said numeric keys are operable for entering numeric data.
wherein said flash memory card is readable by a personal computer;
wherein golf score and handicap information is transferable to a personal computer by use of said removable flash memory card; and
wherein said device assists said golfer to improve their game by keeping an accurate record of events after every stroke during a golf round.
